(19) United States
(12) Patent Application Publication
(10) Pub. No.: US 2015/0145638 A1
(43) Pub. Date: May 28, 2015

(54) ZnO MULTILAYER CHIP VARISTOR WITH BASE METAL INNER ELECTRODES AND PREPARATION METHOD THEREOF

(71) Applicant: Huazhong University of Science and Technology, Wuhan (CN)

(72) Inventors: Qiuyun Fu, Wuhan (CN); Dongxiang Zhou, Wuhan (CN); Yunxiang Hu, Wuhan (CN); Zhiping Zheng, Wuhan (CN); Wei Luo, Wuhan (CN); Tao Chen, Wuhan (CN)

(21) Appl. No.: 14/320,301

(22) Filed: Jun. 30, 2014

(30) Foreign Application Priority Data
Nov. 22, 2013 (CN) 201310594610.4

(51) Int. Cl. H01C 7/10; H01C 17/30

(52) U.S. Cl. CPC H01C 7/10; H01C 17/30
USPC 338/20; 29/610.1

(57) ABSTRACT

Provided are a multilayer chip ZnO varistor with base metal inner electrodes and a preparation method thereof. The varistor is formed by ceramic sheets and inner electrodes which were alternately laminated. Wherein the main material of inner electrodes is the base metal nickel(Ni), both ends of the varistor are coated with silver electrodes. The present invention has the following beneficial effects: (1) the material formula of ZnO varistor is suitable for the preparation process of reduction and reoxidation; (2) the base metal Ni is used as inner electrodes which can sharply reduce the preparation cost of a multilayer chip ZnO varistor; (3) using a conventional solid-phase sintering method, it can complete the burning of silver and the oxidation of the ceramic simultaneously which is suitable for mass production; (4) the nonlinear coefficient of the ZnO multilayer chip varistor produced by the method of this invention can reach 30 or more, the varistor breakdown voltage is less than 20V and the size can be standard chip package size 0805,0603,0402 and 0201.

### FIELD OF THE INVENTION

The invention belongs to the technical field of electronic ceramic components preparation. More concretely, relates to a ZnO multilayer chip varistor with base metal inner electrodes and a preparation method thereof.

### BACKGROUND OF THE INVENTION

Varistor is a passive electronic component which has the nonlinearity I-V (current-voltage) characteristic. It's mainly for overvoltage protection and voltage stabilization. ZnO quickly became the leading material of varistor because of its excellent nonlinear characteristics since firstly successfully developed in 1968 by Panasonic.

The chip varistor began in 1981 which first reported by Panasonic. Using the ceramic green sheets laminated technology and platinum (Pt) inner electrodes. The low-voltage multilayer chips ZnO-based varistor has been successfully developed. TDK, Mitsubishi, EPCOS and some other companies have taken sustained research on the multilayer chip varistor. At the beginning of this century, AVX, TDK, LITTELFUSE, AMOTECH, EPCOS and some other companies have developed the 0402-package multilayer chip varistor in succession. Murata and Panasonic developed the chip varistor with a smaller geometry of 0201-package, its breakdown voltage is as low as 2.5V, and it can meets the ESD protection requirements of semiconductor devices of different performances and structures. Overall, the chip varistor has been researched in recent years. It has achieved remarkable results in the basic research on the materials of chip varistor, as well as its precision manufacturing processes.

Currently the thickness of the single layer varistors typically 1 mm or so, and usually the film thickness of each layer of ZnO multilayer chip varistor can be as thin as several tens micrometers. It can reduce the breakdown voltage by reducing the amounts of grains in single film. National Taiwan University reported the multilayer chip varistor that each layer has only 1-2 grains and is 8 μm of thickness after sintered. With certain thickness for ceramic green sheets, it can also increase the average grain size of ZnO by increasing the sintering temperature, lengthening the sintering time, adding sintering aids and so on to reduce the breakdown voltage. Currently, multilayer chip varistors mainly employ ZnO material systems. Using precious metal silver (Ag), palladium (Pd) as inner electrodes, and prepared by the method of firing in air by once.

With the decrease of layer thickness and the increase of layers number, the mass proportion of inner electrode materials in low voltage multilayer chip varistor is growing. Because the sintering temperature of ZnO varistor materials is generally higher than 1000, it must use the high melting point alloy Ag/Pd (molar ratio of 30:70) as inner electrode material that accounting for over 50% of the total cost. Further, the Bi₂O₃ of ZnO—Bi₂O₃ system is highly volatile in the sintering process, and it can react with the electrode material Pd easily which will reduce device performance. Many researchers and manufacturers are in the study of replaying the Ag/Pd inner electrode by the cheaper silver (Ag) and cooper (Cu) through reduce the sintering temperature of the ZnO chip varistor. In this century, major companies are all looking for ways to reduce the costs because of the high costs of the multilayer chips varistor prepared by this method caused by the sharply increase of Pd and some other noble metal electrodes. Lavrov made the Cu can be co-fired and compatible with ZnO varistor ceramic by the method of electrode position, but the preparation method is very complex; in 2011, Changzhou Star John Technology Co., Ltd. announced a patent about the preparation of ZnO varistors that replace Ag/Pd electrode by pure Ag electrode, but the cost of Ag electrode is still high; it put forward the method of reduction and re-oxide to prepare a multilayer chip varistor which adopt the SrTiO₃ material system and use base metal as inner electrodes in the patent JP2002222703A of TDK, patent JP2005085780A of Panasonic and the patent US20070273468. But it is difficult to overcome the deficiency that the nonlinear coefficient of varistor is very low (below 10), which limits the application field of the varistor.

### SUMMARY OF THE INVENTION

The object of the present invention is to prepare a multilayer low-voltage chip varistor with base metal inner electrodes, while meeting the requirements of high nonlinear coefficient and low breakdown voltage. The present invention uses the base metal material nickel (Ni) replays Ag/Pd and some other noble metal materials to prepare the inner electrode slurry. To prevent the oxidation of the base metal inner electrode, the green body of the multilayer chip varistor with base metal inner electrodes should be co-fired at high temperature in protective atmosphere. And then silver electrodes of both ends of the varistor should be burned at a relative lower temperature in oxidizing atmosphere.

To achieve the above object, we provided a method of preparing a ZnO multilayer chip varistor with base metal inner electrodes according to the present invention, comprising the steps of: p (1) adding the oxides of manganese (Mn) and cobalt (Co) in the mixture of zinc oxide (ZnO) and bismuth oxide (Bi₂O₃), adding deionized water thereto for ball-mill mixing, drying and sieving generated slurry whereby obtaining powders, where a molar fraction of ZnO is 93% to 98.7%, a molar fraction of Bi₂O₃ is 0.2% to 5%, molar fractions of the Mn oxide and the Co oxide are both 0.01% to 5%;

(2) mixing the dispersing agent, defoaming agent, solvent and binder with the powder, and then ball-milled to obtain a slurry casting;

(3) tape casting the slurry whereby obtaining a green sheet, using the base metal nickel (Ni) as inner electrodes, laminating, pressing and cutting into rectangular to obtain molded samples;

(4) sintering the molded samples at the temperature of 850-1150 in protective atmosphere to obtain the ceramic chip varistor;

(5) performing heat treatment thereon in oxygen or air at temperature of 500 to 800, coating silver electrode thereon, and burning Ag. Then, it can get the ZnO multilayer chip varistors with base metal inner electrodes.

Preferably, an oxide of aluminum (Al) and/or an oxide of niobium (Nb) is/are added into the mixture of ZnO and Bi₂O₃, and the total amount thereof being added is no greater than 4 mol %.

Preferably, any one or more of an oxide of chromium (Cr), an oxide of antimony (Sb), an oxide of silicon (Si) and an oxide of vanadium (V) is/are added into said mixture of ZnO and Bi₂O₃, and the total amount thereof being added is no greater than 8 mol %.

The aim of adding the oxides of Al, or Nb, or Cr, or Sb, or Si, or V of any one or more is to improving the nonlinear coefficient of varistor, reducing the leakage current, enhancing the stability and improving the aging characteristics.

Preferably, the duration of ball-mill mixing in said step (1) is 3 to 5 hours.

Preferably, the oxidation process can be performed simultaneously with the burning of Ag electrodes.

As another aspect of the present invention, it also provided a ZnO multilayer chip varistor with base metal inner electrodes based on above-mentioned method.

According to another aspect of the present invention, there is provided a ZnO multilayer chip varistor with base metal inner electrodes, wherein the varistor is generated by alternately laminating ceramic chips and inner electrodes. Wherein said inner electrode is the base metal of nickel (Ni), both ends of the varistor are coated with silver (Ag) electrode.

Overall, according to comparison of the existing technologies with the above technical solution designed by present invention, Advantages of the present invention over the prior art comprise:

(1) the formulation powder of ZnO varistor is suitable for the preparation process of reduction and reoxidation;

(2) the present invention uses the base metal Ni as inner electrode which can greatly reduce the production cost of multilayer chip varistors;

(3) using a conventional solid-phase sintering method, it can complete the sintering of silver and the oxidation of the ceramic simultaneously which is suitable for mass production;

(4) the nonlinear coefficient of ZnO multilayer chip varistors prepared by the method of this invention can reach 30 or more and the breakdown voltage is less than 20V.

### BRIEF DESCRIPTION OF ACCOMPANYING DRAWINGS

FIG. 1 is a schematic diagram of a ZnO multilayer chip varistor with base metal inner electrodes prepared by the present invention;

FIG. 2 is the preparation process flowchart of the varistor proposed by the present invention.

### DETAILED DESCRIPTION OF THE INVENTION

For clear understanding of the objectives, features and advantages of the invention, detailed description of the invention will be given below in conjunction with accompanying drawings and specific embodiments. It should be noted that the embodiments are only meant to explain the invention, and not to limit the scope of the invention.

The main material of the varistor in the present invention is ZnO. Besides, oxides of Bi, Mn and Co are required ingredients. An oxide of Al and/or an oxide of Nb may be added, or one or more of oxides of Cr, Sb, Si and V may be added.

Sufficiently mixing the aforementioned oxides, preparing the green sheets by tape casting, printing base metal inner electrode slurry, then the green body is formed by repeating laminating, printing, laminating, and finally being cut into rectangular after being isostatic pressed.

The aforementioned green body is sintered in protective atmosphere, the sintering temperature is between 850 and 1150, and the optimum sintering temperature is related to the ingredients and the proportions thereof. A ceramic body can't be formed completely if the temperature is too low, and electrical properties of the device deteriorate if the temperature is too high. Coated silver electrode at both ends of the ceramic body and then a laminated chip varistor is prepared by performing heat treatment in oxygen or air at temperature of 500 to 800.

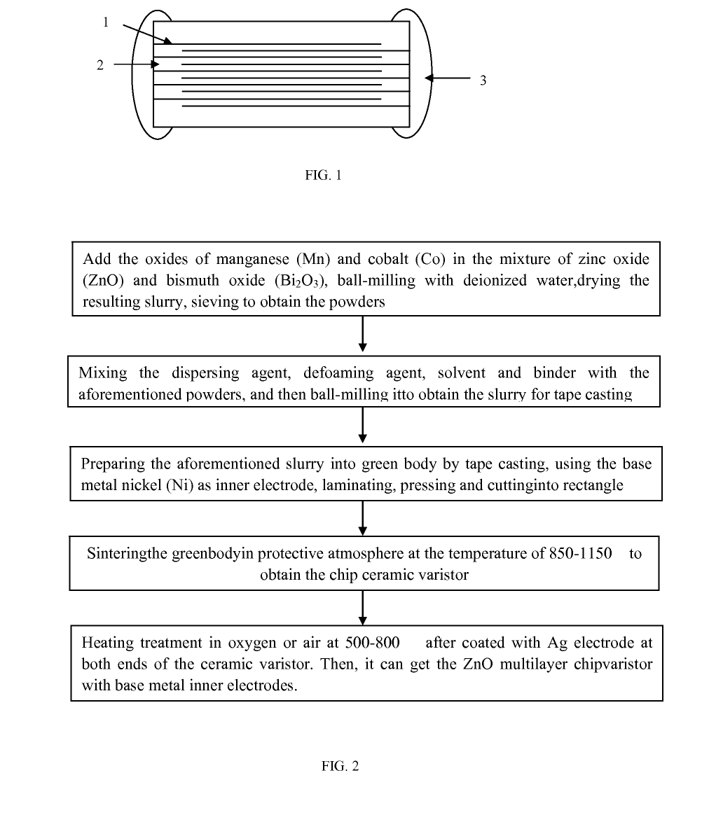

As shown in FIG. 1, it's a ZnO multilayer chip varistor with base metal inner electrodes prepared by the present invention. The varistor is formed by ceramic layer 2 and inner electrode 1 which were overlapped alternately, wherein the material of inner electrode 1 is base metal nickel (Ni), both ends of the varistor are coated with silver (Ag) electrode 3.

As shown in FIG. 2, it provides a method of preparing the ceramic material of a ZnO multilayer chip varistor with base metal inner electrodes to manufacture the ZnO varistor mentioned in the present invention, which contains the following processes:

(1) adding the oxides of manganese (Mn) and cobalt (Co) in the mixture of zinc oxide (ZnO) and bismuth oxide (Bi₂O₃), adding deionized water thereto for ball-mill mixing, drying and sieving generated slurry whereby obtaining powders, where a molar fraction of ZnO is 93% to 98.7%, a molar fraction of Bi₂O₃ is 0.2% to 5%, molar fractions of the Mn oxide and the Co oxide are both 0.01% to 5%;

(2) mixing the dispersing agent, defoaming agent, solvent and binder with the powder, and then ball-milled to obtain a slurry casting;

(3) tape casting the slurry whereby obtaining a green sheet, using the base metal nickel (Ni) as inner electrodes, laminating, pressing and cutting into rectangular to obtain molded samples;

(4) sintering the molded samples at the temperature of 850-1150 in protective atmosphere to obtain the ceramic chip varistor;

(5) performing heat treatment thereon in oxygen or air at temperature of 500 to 800, coating silver electrode thereon, and burning Agelectrode. Then, it can get the ZnO multilayer chip varistor with base metal inner electrodes.

Advantageously, an oxide of aluminum (Al) and/or an oxide of niobium (Nb) is/are added into the mixture of ZnO and Bi₂O₃, and the total amount thereof being added is no greater than 4 mol %.

Advantageously, any one or more of an oxide of chromium (Cr), an oxide of antimony (Sb), an oxide of silicon (Si) and an oxide of vanadium (V) is/are added into said mixture of ZnO and Bi₂O₃, and the total amount thereof being added is no greater than 8 mol %.

The aim of adding the oxides of Al, or Nb, or Cr, or Sb, or Si, or V of any one or more is to improving the nonlinear coefficient of varistor, reducing the leakage current, enhancing the stability and improving the aging characteristics.

The proportion of the organic solvent and the powders in the present invention can be adjusted according to film quality.

Advantages of the invention over the prior art comprise:

(1) the material formula of ZnO varistor is suitable for the preparation process of reduction and reoxidation;

(2) the base metal Ni is used as the main material of inner electrodes in this invention which can sharply reduce the preparation cost of multilayer chip ZnO varistor;

(3) using conventional solid-phase sintering method, it can complete the sintering of silver and the oxidation of the ceramic simultaneously which is suitable for mass production;

(4) the nonlinear coefficient of ZnO multilayer chip varistor produced by the method of this invention can reach 30 or more, the breakdown voltage is less than 20V and the size can be British producer resistance package size 0805,0603,0402 and 0201.

While preferred embodiments of the invention have been described above, the invention is not limited to disclosure in the embodiments and the accompanying drawings. Any changes or modifications without departing from the spirit of the invention fall within the scope of the invention.

1. A method for preparing a ZnO multilayer chip varistor with base metal inner electrodes, comprising the steps of:
(1) adding oxides of manganese (Mn) and cobalt (Co) into a mixture of zinc oxide (ZnO) and bismuth oxide (Bi₂O₃), adding deionized water thereto for ball-mill mixing, drying and sieving to generate a slurry, thereby obtaining powders, with a molar fraction of ZnO is of 93% to 98.7%, a molar fraction of Bi₂O₃ is of 0.2% to 5%, and molar fractions of the Mn oxide and the Co oxide of 0.01% to 5% each;
(2) mixing a dispersing agent, defoaming agent, solvent and binder with the powder, and then ball-milling to obtain a slurry;
(3) tape-casting the slurry and cutting it, thereby obtaining green sheets, using the base metal nickel (Ni) as the main material for inner electrodes, laminating, pressing and cutting into rectangles to obtain molded samples;
(4) sintering the molded samples at a temperature of 850-1150° C. in a protective atmosphere, thereby obtaining a ceramic chip varistor;
(5) performing heat treatment thereon in oxygen or air at a temperature of 500-800 ° C., coating silver electrodes on both ends, and burning Ag electrodes, thereby obtaining ZnO multilayer chip varistors with the base metal inner electrodes.

2. The method of claim 1, wherein an oxide of aluminum (Al) and/or an oxide of niobium (Nb) is/are added into said mixture of ZnO and Bi₂O₃, wherein the total amount being added is no greater than 4 mol %.

3. The method of claim 1, wherein one or more of an oxide of chromium (Cr), an oxide of antimony (Sb), an oxide of silicon (Si) and an oxide of vanadium (V) is/are added into said mixture of ZnO and Bi₂O₃, wherein the total amount thereof being added is no greater than 8 mol %.

4. The method of claim 1, wherein the duration of ball-mill mixing in said step (1) is 3 to 5 hours.

5. The method of claim 1, wherein the oxidation process is performed simultaneously with the burning of Ag electrodes.

6. A ZnO multilayer chip varistor with base metal inner electrodes prepared according to the method of claim 1.

7. A ZnO multilayer chip varistor with base metal inner electrodes, wherein the varistor is generated by laminating alternately with ceramic sheets and inner electrodes, and wherein. the materials of the inner electrodes are the base metal of nickel (Ni), and wherein both ends of the varistor are coated with silver (Ag) electrodes.
